(19) United States
(12) Patent Application Publication
(10) Pub. No.: US 2005/0063026 A1
(43) Pub. Date: Mar. 24, 2005

(54) Calibration arrangement for a scanner

(75) Inventors: John A. Weldy, Rochester, NY (US); Robert W. Kulpinski, Penfield, NY (US)

Correspondence Address: Milton S. Sales;Patent Legal Staff, Eastman Kodak Company, 343 State Street, Rochester, NY, 14650-2201, US

(73) Assignee: Eastman Kodak Company

(21) Appl. No.: 10/669,966

(22) Filed: Sep. 24, 2003

(51) Int. Cl. H04N 1/04; H04N 1/48

(52) U.S. Cl. 358/504; 358/505

(57) ABSTRACT

The present invention relates to a low spatial frequency calibration arrangement for scanning systems. In the method and system of the present invention, calibration is performed to compensate for non-uniformities introduced when light scattering media is scanned. This calibration results in a non-uniformity mapping at each scanning pixel location.

### FIELD OF THE INVENTION

The present invention relates generally to an apparatus for scanning digital color image information from media such as photographic film and more particularly, to a method for calibrating a scanning system.

### BACKGROUND OF THE INVENTION

Scanners are typically calibrated by scanning “open gate” or without any media in the scanning aperture. This calibration technique is useful in removing gain and offset non-uniformities that result from the scanning lens/optics, scanning sensor non-uniformities, and illumination intensity non-uniformities (see, for example, U.S. Pat. No. 5,563,723). However, when scanning media wherein there exists substantial scattering, such as films with significant quantities of retained silver, this calibration method may not remove important non-uniformities. These non-uniformities result from forward scattering caused by the media that alters the angular distribution of illumination, and backward scattering caused by the media that couples with the source illumination cavity to effectively alter the incident illumination profile. Examples of media that have substantial scattering are diffusing media such as photographic films with developed silver (e.g., B/W films), films with retained silver halide, films with significant levels of matte, and reflection media such as paper. Scanner non-uniformity is exacerbated in systems where, in order to achieve a pleasing image, high gain is applied to the scan image signals. Non-uniformity caused by scattering is manifest at very low spatial frequency; oftentimes on the order of five or less cycles per image width. One method for reducing this illumination non-uniformity is to illuminate the media with diffuse illumination; however, this diffusion is achieved by reducing illumination efficiency resulting in lower scanner productivity and other problems caused by long scanning times.

The use of infrared scanning in addition to red, green, and blue scanning is known in the art. Infrared scanning has been used to monitor silver development while not imparting developable latent image to typically spectral sensitized films, (see, for example, U.S. Pat. Nos. 5,337,112 and 5,315,337). U.S. Pat. Nos. 5,266,805 and 6,195,161 have extended this to capture in both reflective and transmissive infrared scanning during development as a means to extract color signal from a color film subjected to black and white development.

Another use of infrared scanning is one where high spatial frequency artifacts are removed. In these cases, careful spatial alignment and/or spatial frequency response matching among the infrared and red, green and blue (RGB) scans is required. U.S. Pat. No. 5,266,805 (for transmissive scanning) and U.S. Pat. No. 6,195,161 (for reflection scanning), are examples of this method whereby high spatial frequency defects such as scratches and dust are removed from the resulting RGB scanned data. Different strategies are used to compensate for scratches which transmit light, and dust which blocks light transmission. Separate correction algorithms are used if a scratch (e.g. allows light to pass; corrected by dividing out on a pixel by pixel basis where detected) is detected and/or dust (e.g. blocks light; corrected by filling in pixels with neighboring pixel information) is detected.

In both of these patents the problem being solved is one of imperfections in the media that is scanned. Specifically, dust, dirt, scratches and smudges are mentioned. The IR channel is used to create a map of these imperfections. In portions of the media where imperfections are detected, the above-mentioned correction algorithms are applied. The algorithm(s) are only applied in areas where indicated by the defect map. The algorithm would typically operate on a very small percentage of the pixels. If an image were severely scratched or contained a large amount of defects, defect repair, (particularly as it is dependent on neighboring pixel information) may not work well. The disclosures of the patents noted above teach the relevance of having good optical alignment between the IR and visible spectrum scans. This is relevant since scratches and dust are high spatial frequency defects.

Issues with the above method include dealing with the algorithmic transitions between blocking light and allowing light (the difference between scratches and dust—what if there is dust overlying a scratch for example); the correction process (division) may be subject to scanner noise; the desired optical alignment of the IR channel and the visible channels typically requires more expensive optics and/or subsequent image processing; and the IR channel may undesirably detect image dye (cyan dyes with significant absorption in the near infrared, such as those in Kodachrome films).

Another use of an IR channel to improve image quality is disclosed in U.S. Pat. No. 6,200,738. The problem solved with IR scanning is to remove the noise caused by retained silver in films that have been photoprocessed, but retain silver. Calculus is applied to 4 channel scan data to reduce image information due to the residual silver. The nature of this “calculus” is to subtract a portion of the IR channel from the visible RGB channels. Subtraction in density is the same as division in transmission. This subtraction is yet another use that relies on high spatial frequency, spatially aligned IR and RGB scans. In addition, aligned scans are also compensated to account for scanner spatial frequency response differences among the scans so that the noise contribution from retained developed (metallic) silver can be removed. This patent further mentions the need to interpolate for missing information that can result from the process.

Drawbacks with this method include dealing with the above mentioned missing image information and the contribution of scanner noise in the subtraction process. The silver image information/noise is correlated, however, the scanner noise is not so correlated. Therefore the contribution of scanner noise to the resultant image will increase with subtraction. Further, the desired optical alignment of the IR channel and the visible channels typically requires more expensive optics and/or subsequent image processing.

The methods discussed above rely on high spatial resolution scans that are spatially correlated (aligned) and of similar spatial frequency response. This requires the use of a scanning system with high, consistent frequency response among the channels, and/or scanning with low scanner noise in order to not impart additional noise owing to the subsequent subtraction. Therefore, it is desirable to have a method and means for reducing non-uniformity that results from a less than totally diffuse scanning geometry used to scan scattering media.

FIG. 1 depicts a conventional method and system for calibrating scanning systems. As shown in FIG. 1, scanner light source 1 illuminates scanning aperture (or gate) 2. The image at the plane of scanning aperture 2 is imaged by a lens 3 onto a sensor 4 where calibration data are collected. The calibration is performed by scanning, in the case of transmission scanning, without any sample in the scanning aperture. This is also known as scanning ‘open gate’. Note that while FIG. 1 shows an area array sensor, the embodiments of this invention are applicable to scanning systems with area and/or linear array sensors.

Scanning with no light, that is light source 1 is extinguished and there is no extraneous light entering the scanning system, and reading out the sensor response to these dark conditions is useful in determining offset compensation.

With the scanning light on, having no sample in the scanning aperture allows the maximum light to be sensed by the scanning elements or pixels. This is useful for performing corrections to compensate for linear gain and offset, that typically vary from pixel to pixel, and for missing pixels, that is pixels with either low or no sensitivity owing to defects that may occur with multi-pixel sensors. This method can also compensate for illumination non-uniformities that result from the optics and geometry of the illumination means or source. Such a calibration technique is described in “Charge-Coupled Devices for Quantitative Electronic Image”, pp 34-37, published by Photometrics Ltd. Typically, a gain and off-set corrections are associated with each scanning pixel location and these corrections are applied during the scanning process. Mathematically, this gain and offset are described by the following equation (1):
I_{c}(x,y)=G(x,y)·[Iₘ(x,y)−O(x,y)] (1)
where at each pixel located at spatial coordinates x and y, I_{c}(x,y) is the corrected scanner transmission, G(x,y) is the gain, Iₘ(x,y) is the measured transmission without gain and offset correction, and O(x,y) is the offset. G(x,y) and O(x,y) are calculated from the dark and open aperture scans.

The above described conventional calibration method is sufficient to calibrate transmission scanning systems wherein non-scattering media are scanned; however, as previously described, the interaction of scattering media with the illumination means or source can result in additional non-uniformities that cannot be corrected by this conventional method. This interaction is depicted in FIGS. 2A and 2B. FIG. 2A shows how a light ray 10 propagates from a light source with an open aperture 20. Light ray 10 from the light source 1 passes through aperture 20 at an angle that it is not seen by a lens 40 and therefore by a sensor 50. A similar ray path is observed when non-scattering media is placed in aperture 20. In FIG. 2B, the addition of scattering media 60 scatters, in various directions, the light ray into multiple light rays 70 of which some are imaged by the lens and subsequently seen by the sensor. In a like manner, some light rays that in the absence of scattering would be detected by the sensor are scattered outside the aperture of the lens and are therefore not detected. Rays in area 70A are seen by the lens and sensor; rays in area 70B are not seen by the lens and sensor.

This scattering is dependent on the geometry of the light source and the nature of the scattering media. Therefore, while the conventional method can compensate for light source geometry non-uniformities, it does not compensate for the non-uniformities created by the interaction of the light source with scattering media.

### SUMMARY OF THE INVENTION

The present invention addresses and overcomes the above-mentioned drawbacks and problems by providing for a low spatial frequency calibration of a scanning system. This calibration serves to remove non-uniformity that is on the order of five cycles or less per the entire field of the scanned image by means of techniques using media in the scanning gate.

In the method and system of the present invention, additional calibration is performed to compensate for the additional non-uniformities introduced when scattering media are scanned. This subsequent calibration step results in an additional non-uniformity mapping at each scanning pixel location. While described as two successive calibration steps, the non-uniformity compensation step, i.e. the application of the conventional compensation and the application of the compensation for non-uniformities introduced by scattering media, can be cascaded into a single compensation step.

The low spatial frequency signature of this scattering induced non-uniformity facilitates solutions to the drawbacks and problems discussed above. Non-uniformity compensation need only be determined at a few locations. Sparsely sampling the image is sufficient to reconstruct a low spatial frequency signature. Additionally, high frequencies can be filtered to eliminate noise without modifying the low frequency compensation.

The present invention therefore relates to a method for calibrating a scanning system which comprises applying a scanning illumination toward an open scanning aperture of a scanning system to determine a low frequency first correction factor for the scanning system; inserting a light scattering media at the open aperture; applying the scanning illumination to the light scattering media to determine a second correction factor to compensate for at least non-uniformities created from a combination of the light scattering media and elements of the scanning system; and combining the first correction factor and the second correction factor to provide for fully corrected image information.

The present invention further relates to a method of calibrating a scan of an image bearing film that comprises scanning a light scattering media; determining a low frequency correction based on the scanning of the light scattering media; and applying the low frequency correction to subsequent image scans.

### BRIEF DESCRIPTION OF THE DRAWINGS

FIG. 1 is a diagram of a conventional calibration system;

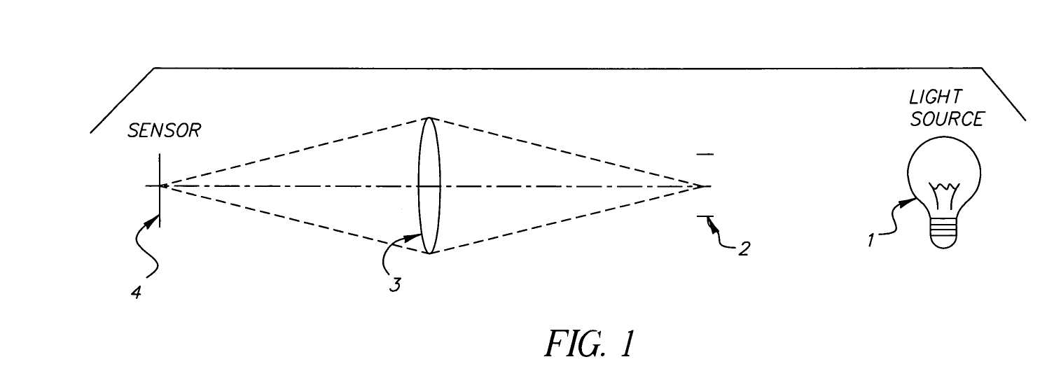

FIGS. 2A and 2B are diagrams that illustrate light scattering;

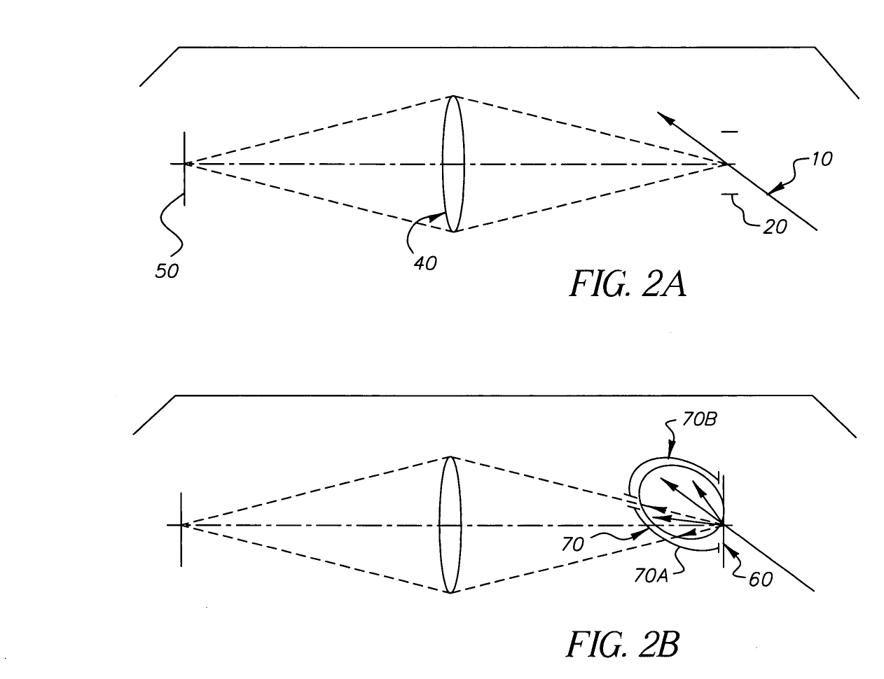

FIG. 3 schematically illustrates a calibrating system, method and/or flow chart in accordance with the present invention;

FIG. 4 is a schematic illustration of an embodiment of a calibrating system in accordance with the present invention;

FIG. 5A is a schematic illustration of a further embodiment of a calibrating system in accordance with the present invention;

FIGS. 5B-5F illustrate a film that can be used for calibration and specifically different scanning positions on the film; and

FIGS. 6A and 6B are schematic illustrations of a still further embodiment of a calibrating system in accordance with the present invention.

### DETAILED DESCRIPTION OF THE INVENTION

In a feature of the present invention, the low spatial frequency signature of scattering induced non-uniformity allows for various solutions to the drawbacks and problems discussed above. For example, any non-uniformity compensation need only be determined at a few points or pixel locations, by sparsely sampling the image as this is sufficient to reconstruct a low spatial frequency signature. In the context of the present invention, low spatial frequency corresponds to frequencies on the order of 5 cycles or less per full field. In addition, since only low frequency information is needed, compensation techniques that are subject to high frequency noise can be considered as high frequencies can be filtered to eliminate this noise without modifying the low frequency compensation. There are several solutions that utilize either or both of these techniques.

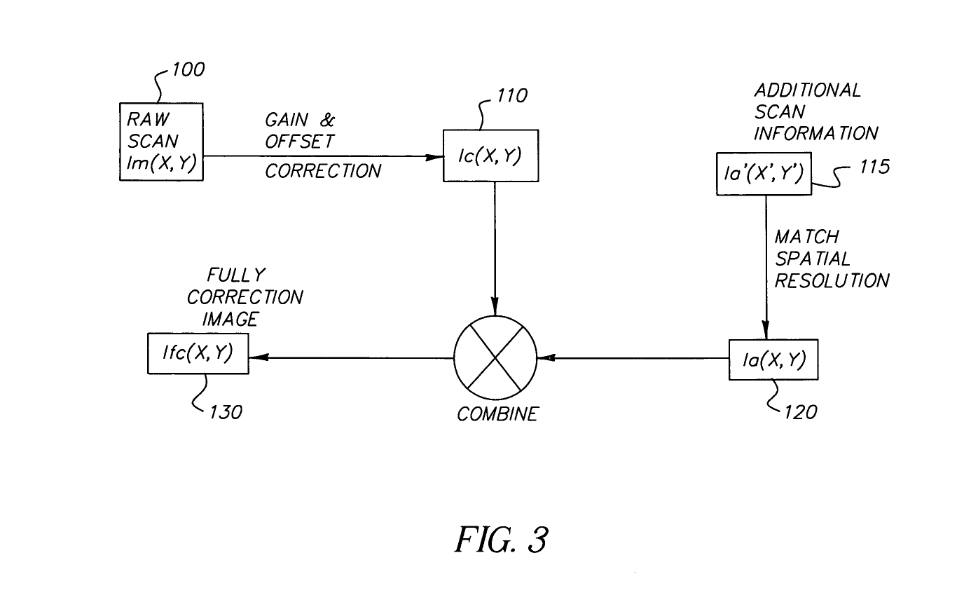

FIG. 3 schematically illustrates a system or flow chart in accordance with the present invention which details steps that can be used to correct non-uniformities induced by the combination of a scattering medium and illumination geometry. The system or elements of the flow chart as shown in FIG. 3 could be part of an on-board computer or CPU of the scanner or could be a stand-alone computer or CPU that is operationally associated with the scanner. As shown in FIG. 3, raw scan Im(x,y) 100 is corrected by the above referenced conventional system to produce corrected scan Ic(x,y) 110. Additional scan information Ia′(x′,y′) 115 is obtained by the various methods further described below. Note that the spatial sampling of Ia′, that is x′,y′ is not necessarily the same as the spatial sampling of Im and Ic. Converting Ia′ to the spatial resolution of Im and Ic yields Ia(x,y) 120 which is the compensating image used to correct for the non-uniformities generated from the combination of the scattering media and geometry of the scanning illumination. Ia(x,y) is then applied to Ic(x,y) 110 to obtain fully corrected (for uniformity) image Ifc(x,y) 130.

A first method or embodiment (embodiment A) in accordance with the present invention includes calibrating with a known diffusing material in the scanning aperture. This could be part of the normally “open-gate” calibration or as a second calibration, with optionally sparse sampling. Like other solutions described below, improved compensation may be possible by functionally relating the non-uniformity in the known diffusing media to that of the scattering media being scanned. For example, in the case of a highly scattering film, the red, green, and blue non-uniformities may be different owing to scanner illumination and/or media characteristics (that could also vary as a function of optical density in the media). These differences can be functionally described and applied, thus providing a further improved compensation for non-uniformity.

There may be an advantage in scanning known diffusing materials of multiple densities and multiple colors. A calibration strip with a series of calibration “images” may be scanned to provide compensation for different colors and densities.

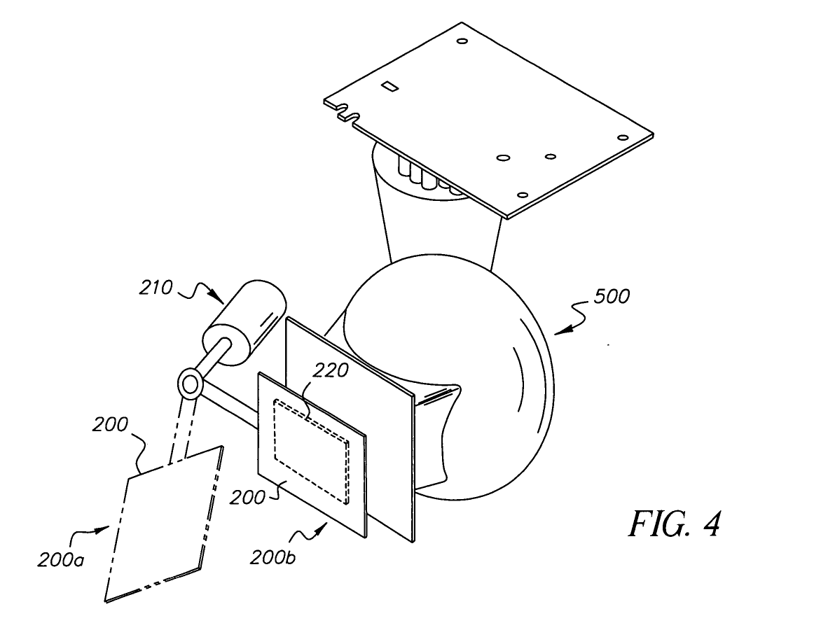

FIG. 4 illustrates embodiment A and shows a system for practicing the first method or embodiment discussed above. More specifically, FIG. 4 illustrates how by inserting a known scattering media into the optical path, it is possible to determine the compensating image, Ia(x,y) directly for all x,y pixel locations. The known scattering material, an example being a diffusing media 200 supplied in package Diffusion Pack #1, FP200 available from Bogen Cine is attached to an actuating device 210 such as a motor and drive shaft operationally associated with material 200 or some other type of automatic or manual driving device. This enables known diffusing media 200 to be inserted into a scanning aperture 220. Position 200a depicts diffusing media 200 removed from an illuminating source 500 as would be the case when performing conventional calibration. Position 200b shows diffusing media 200 placed in the path of a light output from illuminating source 500. Illuminating source 500 is illustrated as a cavity type illuminating source which can include LED's. However, the present invention is not limited to this illuminating source and it is recognized that other types of illuminating sources can be used. After the conventional gain and offset have been applied and while diffusing media 200 is in position 200b, a scan of known diffusing media 200 is performed. The result of this scan is Ia′(x′,y′) for every pixel. Other scattering media examples include opal glass, ground and sandblasted glasses, neutral density films, unprocessed photographic films, and holographic films.

A further method or embodiment (embodiment B) in accordance with the present invention includes calibrating with the media that is to be scanned. For example, if there is an area of a scattering photographic film without image modulation (e.g. a flat uniform exposure, or no exposure) then some of the media characteristics that impact this non-uniformity are better determined with this enhanced calibration method. In some cases, a flat exposure or non-exposure frame may not be available. However, in this case, as we only require a few sample points, it is possible to scan a small area with no exposure, such as the interframe gap in 35 mm photographic films, at a few locations in the scanning aperture. The low frequency nature of the non-uniformity allows one to reconstruct the full frame non-uniformity from a few points.

In the case of a one-time-use camera, such as the Kodak MAX flash camera, a portion of the film that is not exposed can be scanned. The first or last frame on the film may be assumed to be unexposed, depending on manufacturing processes. Alternatively, a known exposure can be made during manufacturing. The scanner can use the known exposure to carry out calibration.

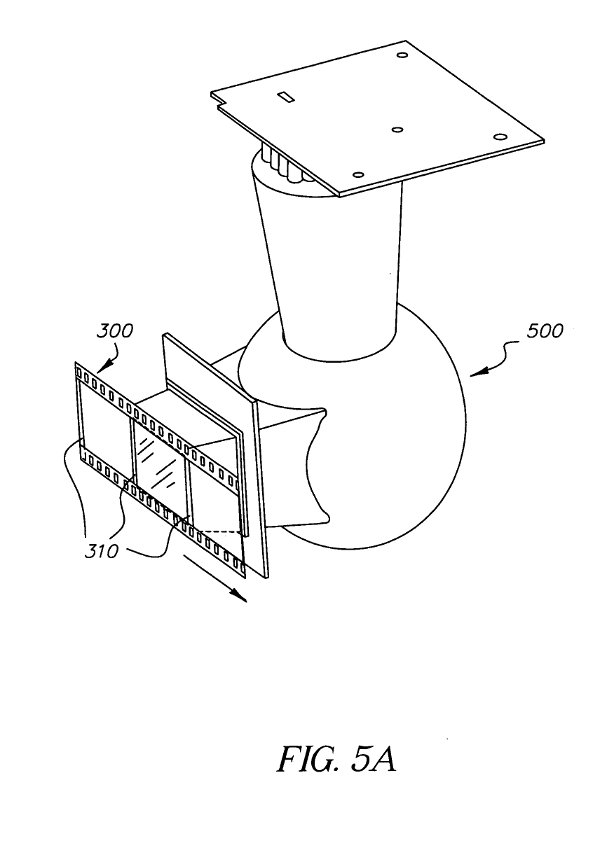

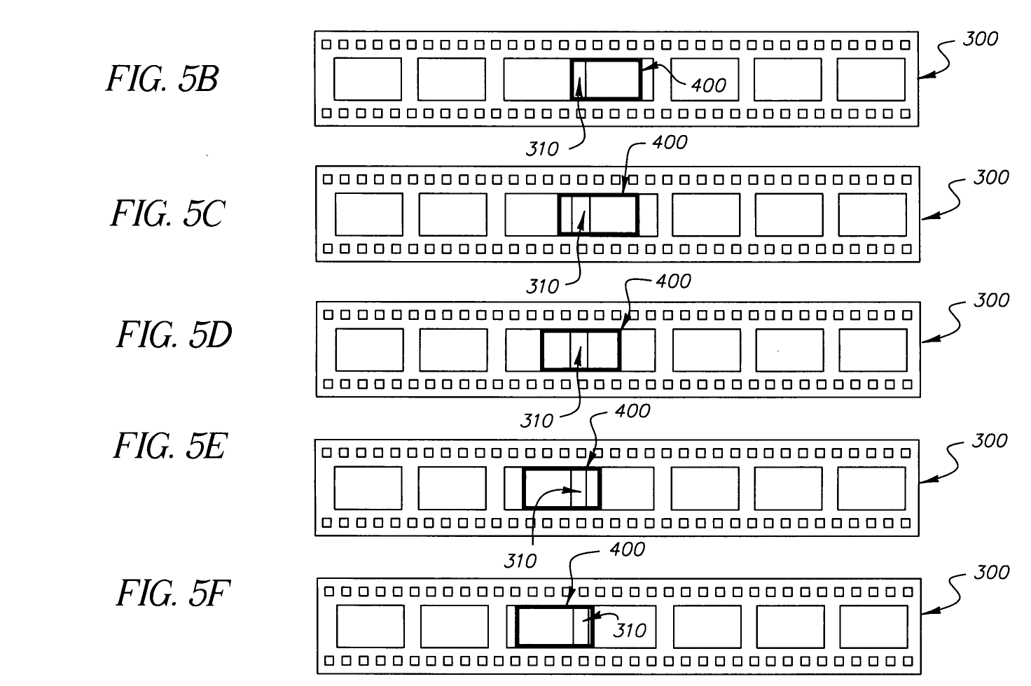

FIG. 5A illustrates embodiment B and shows a piece of 35 mm size film 300 with scattering that we wish to both perform the calibration needed to calculate Ia(x,y) and scan image data. Ia(x,y) is determined by scanning an area of the film that has no image modulation, in this example, an inter-frame gap 310 which has no exposure, as it traverses an illumination aperture 400 (see FIG. 5B). As previously noted, the non-uniformity resulting from the interaction between scattering media and the illumination geometry is very low in spatial frequency. Given this observation, inter-frame gap 310 need not be scanned at every x,y location in the illuminating aperture; rather as few as 5 positions as shown in FIGS. 5B-5F, are sufficient to characterize the non-uniformity. As shown, FIG. 5B represents a first position; FIG. 5C represents a second position; FIG. 5D represents a third position; FIG. 5E represents a fourth position; and FIG. 5F represents a fifth position. Results from these 5 positions are then spatially interpolated to yield a full resolution Ia′(x′,y′) compensating image.

A third method or embodiment (embodiment C) in accordance with the present invention involves scanning the image with an additional channel. Typically, color photographic materials are scanned with 3 colors—red, green, and blue. By scanning with a fourth color, such as infrared, which does not read the visible image dyes, it is possible to determine the uniformity compensation without interference from imaging dyes. Alternatively, it is possible to scan in the visible portion of the spectrum, preferably at a dominant wavelength where the modulation of the image dyes is low compared to the modulation with the red, green, and/or blue scans. In these cases, the fourth channel is subtracted from the red, green, and blue scans, and the color gains (and possibly color matrixing) of the red, green, and blue scans appropriately modified. Now this modification may result in noise (e.g. subtracting two visible spectrum signals and then adjusting gains); however, again, the very low frequency nature of this non-uniformity compensation allows for aggressive noise filtering, making use of a fourth channel, in particular a fourth channel in the visible spectrum, possible.

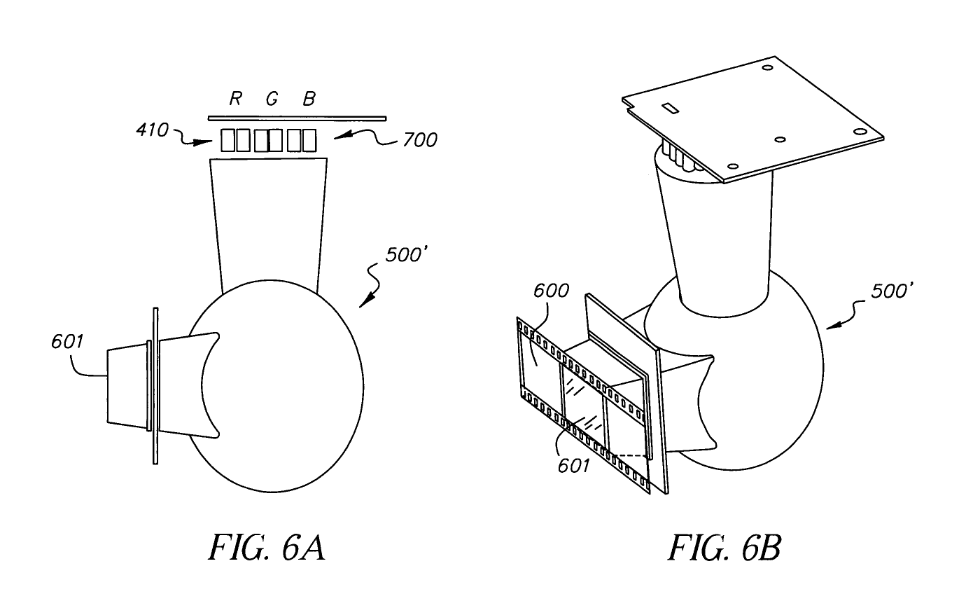

FIGS. 6A and 6B illustrate embodiment C and show an illumination source 500′ that can illuminate with more than 3, typically red, green and blue, wavelengths of light. With scattering media 600 containing image information placed in an illuminating aperture 601, red, green and blue scans (from, for example, red, green and blue LED's 700) are performed to obtain the uncorrected RGB image data. At the same time, a fourth channel or an additional wavelength of light 410 to be used to compensate for non-uniformities induced by scattering, is acquired. In order to avoid excessive gains in subsequent color calibration, this fourth channel 410 is best located away from the peak discriminating wavelengths for red, green, and blue modulating dyes. Wavelengths between red and green or blue and green peaks or either side of the red and blue peaks, for example, infrared or ultraviolet are candidate wavelengths. This fourth channel scan becomes Ia′(x′,y′). As some image dye modulation may be seen by this fourth scan, subsequent color calibration must be performed after the scattering non-uniformity has been compensated.

As only low spatial frequency information is required, then Ia′(x′,y′) does not have to be in good focus or in good registration with the image data scans. In fact, in order to reduce noise with this and the previous methods, it is desirable to perform a low-pass spatial filter to reduce noise in Ia′(x′,y′).

For the purpose of performing the compensation, taking Ia′(x′,y′), generated by any of the above methods of embodiments A, B, C, a full spatial resolution image, Ia(x,y) is created (if needed) by spatially interpolating Ia′(x′y′) to the same resolution as Ic(x,y). The conventional gain and offset corrected data Ic(x,y) are now further corrected to eliminate the non-uniformity induced by the interaction of the scattering media and the illumination source. In the case of embodiments A and B, full color scans can be obtained, that is, Ia(x,y) possesses 3 channels RGB data as does Ic(x,y). The correction for this interaction is performed as shown in equation (2) as follows:

$${I}_{cfQ} ( x , y ) = {K}_{Q} \cdot \frac{{I}_{c} ( x , y )}{{I}_{a} ( x , y )} \qquad ( 2 )$$

Where IcQf(xy) is the fully corrected image for channel Q and K_{Q} is an optional gain constant, with potentially different values depending on channel Q, that may be useful. When Ia(x,y) possesses less than 3 channels, then the appropriate channel from Ia(x,y) is used in compensating each color channel. In the case where Ia(x,y) is a single channel, then the same Ia(x,y) values are used in compensating each channel and Kc adjusted as needed.

With all of the methods of embodiments A, B, C discussed above, this information can be further improved by applying low-pass spatial filtering to reduce noise in the final compensating image. As the scattering induced non-uniformity is typically very low in spatial resolution (on the order of 5 or less cycles per image width), this low-pass filtering can be very aggressive. In addition, this low spatial resolution nature of the final compensating image can accommodate registration errors between the final compensating image and the target image to be compensated. Furthermore, consistent with sampling theory, only a few samples or pixels are required to fully describe the final compensation image.

The type of information that is acquired in the method of embodiment A is the transmission (or density which is −log10 (transmission) of the diffusing material. As is the case with the subsequent methods of embodiments B and C, this information is first normalized, e.g. in the case of density adjusted to have zero mean by subtracting the mean value based on all of the scanned pixels from each pixel. For convenience assume that the conventional non-uniformities and non-uniformities introduced by the scattering media interaction with the scanner illumination source are cascaded into a single non-uniformity image. This compensation image is determined and stored either as a separate step or as the target images are being scanned. Having scanned and stored the target images, the stored non-uniformity image is subtracted (in log space) from the target image(s) yielding uniformity compensated target images. The uniformity compensated target images can then be input to subsequent image processing steps depending on the overall aims of the image processing system. Example subsequent image processing steps may include adjusting tone scale, color, spatial sharpness, noise levels, and the like.

All of the above solutions of embodiments A, B and C can be used solely or in combination. Further enhancements are possible by recording the history of the non-uniformity and providing a feedback arrangement to modify the non-uniformity compensation and or detect possible failures in the illumination system. For example, full film roll and roll-to-roll uniformity can be tracked and possibly averaged before applying to the current and/or subsequent rolls.

The invention has been described in detail with particular reference to certain preferred embodiments thereof, but it will be understood that variations and modifications can be effected within the spirit and scope of the invention.

1. A method for calibrating a scanning system, the method comprising the steps of:
applying a scanning illumination toward an open scanning aperture of a scanning system to determine a first correction factor for the scanning system;
inserting a light scattering media at the open aperture;
applying the scanning illumination to the light scattering media to determine a subsequent low frequency correction factor to compensate for at least non-uniformities created from a combination of the light scattering media and elements of the scanning system; and
combining the first correction factor and the second correction factor to provide for fully corrected image information.

2. A method according to claim 1, wherein said light scattering media is a diffusing material having known properties.

3. A method according to claim 1, wherein said light scattering media is a diffusing material having multiple densities and colors.

4. A method according to claim 1, wherein said step of inserting the light scattering media at the open aperture comprises moving the light scattering media from a first position which is displaced from the open aperture to a second position which is in front of the open aperture.

5. A method according to claim 1, wherein said light scattering media is photographic film and said step of applying the scanning illumination to the light scattering media comprises scanning at least one position of an inter-frame area of the photographic film which does not include image information.

6. A method according to claim 1, wherein said step of applying the scanning illumination comprises scanning the media with red, green, blue and an additional wavelength of light.

7. A method according to claim 6, wherein said additional wavelength of light is infrared light.

8. A method according to claim 6, wherein said additional wavelength of light is visible light with a dominant wavelength located away from film dye peaks.

9. A method of calibrating a scan of an image bearing film, the method comprising the steps of:
scanning a light scattering media;
determining a low frequency correction based on the scanning of the light scattering media; and
applying the correction to subsequent image scans.
